(19) United States
(12) Patent Application Publication
(10) Pub. No.: US 2011/0139476 A1
(43) Pub. Date: Jun. 16, 2011

(54) GARDEN TOOL HAVING AT LEAST ONE WORKING BLADE

(76) Inventors: Jochen ROSER, Ludwigsburg (DE); Steffen PETEREIT, Freiberg A.N. (DE)

(21) Appl. No.: 12/956,838

(22) Filed: Nov. 30, 2010

(30) Foreign Application Priority Data
Dec. 10, 2009 (DE) 10 2009 047 348.3

(51) Int. Cl. B23Q 5/00

(52) U.S. Cl. 173/141

(57) ABSTRACT

The invention relates to a garden tool having at least one working blade for performing a cutting operation. The garden tool includes a user control part for user activation of the garden tool. A drive unit generates a working motion of the at least one working blade which has a blade region for a linear and/or oscillating working motion of the at least one driven working blade An electronic unit acts upon the drive unit with at least control and/or regulating signals, and an operating voltage unit furnishes an electrical energy supply to the electronic unit. It is proposed that the drive unit includes at least one excitation actuator having a volume of excitation-active material, which actuator is electrically supplied in operation by the operating voltage unit and is controlled or regulated by the electronic unit.

### CROSS-REFERENCE TO RELATED APPLICATION

This application is based on German Patent Application 10 2009 047 348.3 filed on Dec. 1, 2009.

### BACKGROUND OF THE INVENTION

1. Field of the Invention

The invention is based on a garden tool having at least one working blade for performing a cutting operation.

2. Description of the Prior Art

Generic garden tools are tools that serve especially to maintain gardens and parks. One possible way of classifying garden tools can be those for working the soil, for sowing and planting, for fertilizing, for mowing the grass, for cutting, for picking fruit, and for watering and spraying. The electrically driven garden tool in question here includes at least one working blade, and this working blade can be suitable for cutting, scratching the soil, or plowing. Such garden tools can be used as a branch saw, tree trimmer, shrub trimmer or furrow maker, garden composting device, pruning knife, lawn clipper, girdling tongs, rose cultivator, three-pronged cultivator, sickle, weeder, verticulator or aerator, or the like. All these garden tools have in common the fact that they have at least one working blade cutting, scratching the soil, or plowing.

In the prior art, motor-operating garden tools are known which in most cases include an electric motor or internal combustion engine, which generates at least a rotational and sometimes also a translational motion in order, by way of a suitable gear or mechanical conversion, to drive one or more working blades for performing a working motion, in particular to perform a cutting or scratching or plowing motion. Grass-cutting tools, in particular rotary mowers, bar mowers or spindle mowers should be considered in further detail, for example. Spindle mowers include a rotating spindle on which an upper knife is disposed, which cuts the grass by moving counter to a fixed lower knife and thus performing a scissorslike cutting operation. Analogously to spindle mowers, bar mowers have a series of fixed, fingerlike lower knives, by way of which a strip with triangular upper knives is moved back and forth. In other versions, the upper and lower knives both move counter to one another. In their construction, these are approximately equivalent to a motor-powered hedge clipper that cuts on one side, or a greatly enlarged hair-cutting clipper. Bar mowers also operate on a scissorslike principle and have the same advantages and disadvantages as spindle mowers. The most widely used are known as sickle or rotary mowers. They have horizontally disposed cutting knives that rotate at high speed and beat against the grass; by means of one or more sharp working blades, the grass blades are cut all the way through. The majority of manual lawn mowers are sickle mowers, and some versions have working blades in which two knives are disposed one above the other. The cutting working blades can be screwed-on knives or polished knife bars. Examples used in large-scale agriculture are known as gyromowers.

All these motor-driven garden tools with at least one working blade are based on the method in which fast-moving knife blades perform a cutting operation by means of a long mechanical stroke. The fast-moving knife blades with a relatively long cutting stroke represent a high risk of injury to a user or to creatures in the grass. Moreover, because of the strong mechanical forces that such a cutting tool exerts, there is considerable potential for damage from edging stones, decorative plants, or other objects hidden in the grass, and these objects also include power cords to electrically driven lawn mowers. Moreover, such motor-driven tools, because of the drive and the cutting noise, are relatively loud, and even the use of an intrinsically low-noise electric motor drive is associated with a high noise pollution potential because of the large mechanically moved masses. With regard to lawn mowers, there is also the problem that partly for technical reasons, the grass blades are cut very raggedly and the cut edge of the grass blades is often heavily damaged, causing the die-off of the upper areas of the blade of grass and thus leading to an unattractive brown coloration of the tips of the grass.

### SUMMARY AND ADVANTAGES OF THE INVENTION

The invention relates to a garden tool having at least one working blade for performing a cutting operation. To that end, the garden tool includes a user control part for user activation of the garden tool, a drive unit for generating a working motion of the at least one working blade, a blade region for a linear and/or oscillating working motion of the at least one driven working blade, an electronic unit for acting upon the drive unit with at least control and/or regulating signals, and an operating voltage unit for furnishing an electrical energy supply to the electronic unit.

It is proposed that the drive unit includes at least one excitation actuator having a volume of excitation-active material, which actuator is electrically supplied in operation by the operating voltage unit and is controlled or regulated by the electronic unit.

Electric garden tools of the generic type in question are as a rule portable and can be held by a user in his hand during operation; they can be operated in cordless fashion by way of battery packs or by means of a plugged-in connection cord. If the excitation actuator is supplied electrically by means of a battery-operated or plugged-in voltage unit and is controlled or regulated by the electronic unit, then it can be operated at a frequency, in particular a resonant frequency of the entire mechanical system, so that a high initial mechanical capacity and as a result high efficiency can be made available. The excitation actuator can be ultrasonic excitation actuator. The excitation actuator vibration system that generates a mechanical vibration frequency is as a rule coupled to components that are coupled to the vibrator, in particular components that transmit the ultrasound in amplified fashion (boosters) and to a place of use (sonotrodes). These make it possible to reduce the structural size in order to furnish a compact tool. It is also possible for a plurality of excitation actuators, which serve to drive one or more working blades, to be operated at the same or a different excitation frequency. Alternatively, however, one or more further work components, such as an electric motor or internal combustion engine, can be provided. The various drive components and drive concepts can be employed in alternation or in combination. If the at least one excitation actuator is operated at a resonant frequency of the mechanical drive system, then the power yield is especially high, so that for a given initial capacity, the garden tool can be made especially compact, which is favorable for the sake of convenient manipulation. The garden tool can be operated in cordless fashion with a battery or rechargeable battery or in addition or alternatively can be plugged in, using via a power cord.

Depending on the intended application, the drive unit can be detachably connected to the working blades, or a fixed connection can exist between the drive unit and the working blades. This connection can be of the material-locking or force-locking kind. The garden tool serves in particular for handling the most various kinds of cutting, scratching or milling work in the garden, and in arbitrary gardens it can be used to drive one or more working blades. For that purpose, it is entirely conceivable for a part of the garden tool, embodied as a drive block, and for instance including the drive unit with a user control part, electronic unit and operating voltage unit, to be capable of being uncoupled mechanically from the working blade or working blades or a torso unit that includes the working blades and other mechanical force-transmitting components, so that this work block of the garden tool can be mechanically attached to other torso units with a working blade. Thus various garden tools can all be operated with only one drive block, and thus a series of drive-adaptable garden tools can be created that can be used flexibly and procured inexpensively.

In an advantageous further development of the invention, the electronic unit can be embodied for operating the at least one excitation actuator at a resonant frequency, and preferably the electronic unit includes a roger with frequency adaptation for follow-up of the resonant frequency of the least one excitation actuator. Thus the electronic unit furnishes control and regulating signals in order to operate the excitation actuator at a resonant frequency for attaining the highest possible power yield and to make a compact design of the drive unit possible. To that end, a sufficiently high quality of the vibration system can be utilized in order to furnish a high mechanical initial power with high efficiency and low energy consumption; the quality of the undamped vibration system can reach values typically above 300 to above 2000. If the electronic unit is provided with a regulating unit that serves the purpose of frequency adaptation for follow-up of the resonant frequency of the at least one excitation actuator, then the resonant frequency can be adapted continuously, for instance if because of some other intended use a change of the tool coupled to the excitation actuator is necessary, or if when the tool is stressed the resonant frequency of the excitation actuator changes. Thus in operation, an optimal power yield is always made possible. Advantageously, the electronic unit can include a phase regulating chain with which the resonant frequency can be excited with high precision. Thus a phase displacement between the electrical current and electrical voltage supplied to the volume of excitation-active material for exciting the ultrasonic vibrations can be adjusted to and kept at a fixed value, in particular a zero-degree phase difference between the current and voltage, thus making it possible to attain an optimal mechanical power yield.

In a favorable refinement of the invention, the excitation-active material of at least one excitation actuator can be piezoelectric or magnetostrictive, and preferably the at least one excitation actuator can reach a vibration amplitude at the tip of the blade in the range of from 5 μm to 100 μm. Thus the excitation-active material of at least one excitation actuator can be a piezoelectric material, in particular a piezoelectric ceramic, so that when an electrical voltage is applied, the piezoelectric material is deformed. As the piezoelectric material, piezoelectric crystals, piezoelectric ceramics, or piezoelectric thin films can be considered in particular. Alternatively or in addition, one or more excitation actuators can also be driven by means of a magnetostrictive material. They deform in volume as a result of an applied magnetic field. In the process, the body at constant volume experiences an elastic change in length, which is excellently well suited for use in a linear drive or for generating a linear vibration. The driving magnetic field can be output to the electrostrictive material by means of a magnet coil through which current flows and by means of an iron core. Thus the excitation actuator can be embodied as a piezoelectric Langevin vibrator or as a magnetostrictive vibrator. In particular, it is also advantageous if the excitation actuator at the tip of the blade can attain a vibration amplitude in the range of 5 μm to 100 μm. This kind of high vibration amplitude is advantageous for good power transmission to the working blade and thus for a high cutting output by the garden tool.

In a further advantageous embodiment, the operating frequency of the at least one excitation actuator in operation can be between 10 kHz and 1000 kHz, preferably between 15 kHz and 60 kHz, and in particular over 20 kHz. Because the excitation frequency is so high, in the ultrasonic range, on the one hand with increasing frequency the structural size of the excitation components and the mechanical stress on the vibration system drop, and in the selected frequency range, advantageous size ratios with a high output power are attained with a favorable weight for the garden tool. Moreover, by means of an excitation frequency above the typical audible frequency of a human being, which is typically in the range between 30 and 16,000 Hz, an excitation actuator is created whose operation takes place practically inaudibly to the human, so that there is only very slight noise pollution, or none at all, from the operation of the garden tool. This makes quiet, pleasant work with the garden tool possible.

In a favorable further development of the invention, the operating voltage unit can include an electrochemical reservoir, in particular a rechargeable electrochemical reservoir. Alternatively or in addition for this purpose, the operating voltage unit can include a current generator, in particular a photovoltaic module unit or an internal combustion engine current generator, preferably for charging and recharging the rechargeable electrochemical reservoir. For operating the excitation actuator and the electronic unit, a supply of electrical voltage by the operating voltage unit is necessary, so that the operating voltage unit can fundamentally either be connected directly to an electrical grid by plugging in a power cord, or it can include a constant current source in the form of an electrochemical reservoir, in particular a battery or a rechargeable battery. Such transportable electrochemical reservoirs make the garden tool independent of a cord and allow it to be used in any arbitrary place. Precisely in remote regions or where one is far away from where a battery can be replaced or recharged, it can be advantageous if the garden tool can have recourse to an alternative or additional current source. For that purpose, it is advantageously conceivable for a photovoltaic module unit, whose generated current can recharge a battery by means of solar energy over long idle phases of the garden tool, to be attached to the garden tool, or for an internal combustion engine current generator, which in operation either furnishes enough current to drive the electronic unit and the drive unit directly, or for recharging a battery, to be provided in the operating voltage unit, so that in operation, current can continue to be furnished by an electrochemical voltage source.

In a favorable further development of the invention, the garden tool can include one or more optical and/or acoustic and/or haptic function displays for displaying an active state of the at least one excitation actuator. The display can be done optically and/or acoustically and/or haptically, for instance by means of vibration. The operating safety of the garden tool can be enhanced thereby, because it is clearly apparent whether the excitation actuator is activated and mechanical power is being output, or if the working blades are performing a cutting motion. This is particularly important whenever the working frequency of the excitation actuator is above the audible frequency of human hearing, in which case a user cannot conclude what the operating state of the garden tool is from the working noise of the excitation actuator and there is accordingly the danger that, with the excitation actuator activated, he can get into the vicinity of the working blade and might injure himself.

In an advantageous exemplary embodiment of the invention, the garden tool can be embodied as a lawn mower, and the working blade can be embodied as a grass-cutting blade, and the grass-cutting blade can be movable by means of a carriage to an adjustable height above the grass to be cut. By driving at least one working blade by means of an ultrasonic excitation actuator, a lawn mower can be created with which cutting blades of grass can be done very quietly, exactly, and with little damage; the working blade does not have to be guided at high speed and with a long cutting stroke—except for the vibration motion with amplitudes between 5 μm and 100 μm. Because of the inaudible or hardly audible operating frequency of the excitation actuator, which is typically above 20 kHz (usually 15 to 60 kHz), the entire grass-cutting operation can be done absolutely noiselessly. The ultrasonically excited working blades can be embodied such that with them, the edges of the grass surfaces can be cut off exactly, even for example at a trimming stone or edging stone or along a garden fence. Because of the slight mechanical working motion of the blades and the gentle cutting operation, the blades can be guided to the outermost edge of the lawn mower, so that grass can be cut cleanly to near a masonry wall or a fence, and without objects located in the grass being damaged or creatures being injured or killed.

Further in the aforementioned advantageous further development of the garden tool as a lawn mower, it is conceivable and advantageous that the lawn mower includes a brush device, which can guide the grass to be cut toward the working blade by means of a brush motion, in particular a rotary brush motion. If a carriage moves the working blade of the lawn mower at an adjustable height over the grass to be cut, then only grasses that are high enough and that can be positioned counter to the pressing force of the working blade are cut. Using a brush device whose brush motion serves to guide even the grass located close to the soil toward the working blade makes it possible for all grasses, even grasses that have been compacted, to be engaged by the working blade and cut off cleanly. Favorably, the cut material can be fed into a collecting container with the aid of the brush device and/or other feeding devices.

In a further practical embodiment of the garden tool, the garden tool can be embodied as a clipper, in particular as a hedge clipper, and the working blade can be embodied in particular as a hedge clipper blade or multi-blade hedge clipper with a counterpart blade or counterpart blades, or as a branch lopper in which the working blade is embodied as a branch lopper blade or multi-blade branch lopper with a counterpart blade or counterpart blades. For that purpose it is conceivable for the hedge clipper or branch lopper to include a single working blade with a counterpart blade with an undulating cut, but it is also conceivable for the hedge clipper or branch lopper, analogously to an electric hedge clipper, to have a sword for instance, in which a row of fixed knives is secured, typically to the right and left, on a fixed strip, with the spacing of the knives corresponding to the maximum diameter of branch to be cut; above it a second bar, also equipped with knives, can be moved back and forth by means of one or more excitation actuators, so that the knives of the bar form a fixed, long row of individual clippers. If the hedge clipper or branch lopper is embodied as a single clipper, then its cutting working blade preferably has a length of approximately 30 vibration amplitude; the cutting edge can be curved inward and can have undulating cutting edges. The ultrasonic working blade can for instance make small cutting motions by means of minimal axial rotation of the working blade relative to the fixed counterpart blade, so that by means of a slight manual or motor-driven cutting or tongs motion of the two clipper blades toward one another and by means of the vibrational motion superimposed by the ultrasonic driving actuator, it becomes easy to cut through dense hedges, thick branches, or tree stumps.

Finally, in an advantageous exemplary embodiment, the garden tool can be embodied as a spade or verticulator, and the working blade can be embodied as a spade blade or as one or more verticulator blades. A spade serves to loosen, turn over or move soil; the spade handle is fastened firmly in a spade body. When the spade is pushed into the soil, the working blade of the spade body serves to penetrate the surface of the soil and to cut apart root systems. If this working blade is also excited by means of high-frequency mechanical vibrations, then the process of inserting a spade into hard, stuck-together soil and dense root systems, in particular, is easy to do. Analogously, verticulators include a series of verticulator blades, which serve to begin to scratch a grass scar in a lawn area, to remove mulch or moss and to promote aeration of the soil. Rotating spring steel knives or springs can scratch vertically into the soil. This scratching motion can be either supported or done solely by means of an excitation actuator; controlled mechanical scratching of the soil and guidance of the scratching to an exact millimeter depth can be done relatively noiselessly.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows one exemplary embodiment of a garden tool of the invention in the form of a lawn mower;

FIG. 2 shows a further exemplary embodiment of a garden tool of the invention in the form of a hedge clipper;

FIG. 3 shows a further exemplary embodiment of the invention of a garden tool in the form of a branch lopper;

FIG. 4 shows a further exemplary embodiment of a garden tool of the invention in the form of a spade; and

FIG. 5, in a schematic view, shows the mode of operation of the various units of a garden tool of the invention.

### DESCRIPTION OF THE PREFERRED EMBODIMENTS

In the drawings, identical or similar components are identified by the same reference numerals.

To explain the invention, FIGS. 1 through 4 show various possible uses of ultrasonically excited garden tools, in the form of exemplary embodiments with an ultrasonic excitation actuator for operating one or more working blades.

For this purpose, FIG. 1 shows a version of a garden tool 10 as a lawn mower 30, which is guided over grass 28 that is to be cut. For that purpose, the lawn mower 30 is mounted on a carriage 26, which makes it possible to dispose the working blade 18 at a defined working height, to attain an adjustable cutting height of the grass 28 that is to be cut. The lawn mower 30 includes a user control part 12, which is disposed on the upper end of the carriage 26, so that it can be easily reached by the user; at the upper user control part of the garden tool 10, the user finds a haptic function display 40, which vibrates when the lawn mower 30 is in operation and as a result signals that the excitation actuator 24 is in operation. The lawn mower 30 further includes an operating voltage unit 22 and an electronic unit 20, which are disposed, encapsulated in modular fashion, on the carriage 26, and also includes a rechargeable battery, for instance, as well as a power pack for supplying current through a cord and for battery charging, and control electronics for triggering the excitation actuator 24. The battery voltage and electronic unit 20, 22 is connected by means of a cord to a drive unit 14 in which the excitation actuator 24 is disposed. If the excitation actuator 24 of the drive unit 14 is subjected to electrical signals, then it executes a high-frequency mechanical vibration, which drives the blade region 16 of the working blade 18 by means of a linear, high-frequency mechanical vibration, so that a mechanical cutting motion is executed in order to cut off the topmost tips of the grass 28 to be cut. To reinforce the cutting action, a brush device 46 is used, which is designed as a roller brush device and this roller motion serves to press grass toward the working blade 18, oscillating at high frequency, so that even grass that has been compacted can be cut off reliably to the desired height. A system comprising a booster and a converter for high-frequency mechanical vibration excitation is disposed inside the drive unit 14 but not shown. Depending on the user specification, the drive unit can be switched on and off by means of the user control part 12. The operating voltage unit 22 can be supplied by means of either a rechargeable battery or a power cord. With the carriage 26, embodied simply, the working blade 18 can be guided at an appropriate height above the surface of the grass 28 in order to shorten the grass to the desired height. To improve the outcome of cutting, the grass blades can also be set upright with the appropriate brush device 46, analogously to what happens with the conventional harvester thresher and guided toward the working blade 18. To protect against injuries, the working blade can continue to be provided with a suitable guard basket.

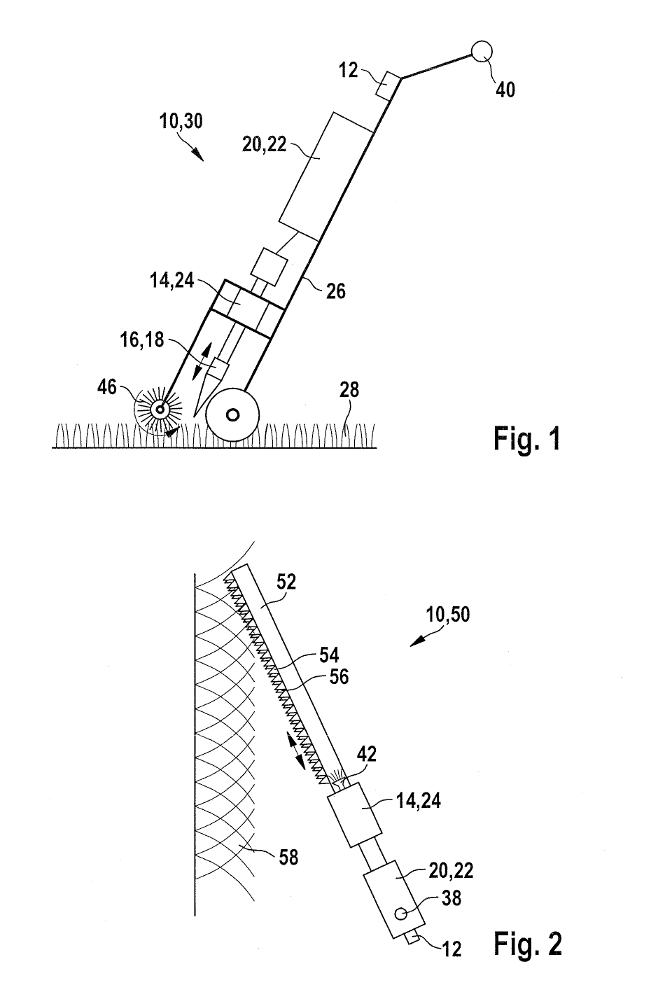

FIG. 2 schematically shows the embodiment of a garden tool 10 as a hedge clipper 50, which is embodied for trimming a hedge 58 that is to be cut. For that purpose, the hedge clipper 50 includes a scissors blade 52, approximately 60 vibration amplitude long, which is constructed in two parts; on the underside, a series of hedge clipper counterpart blades 56 are disposed in fixed fashion, and a series of linearly oscillatingly moved hedge clipper blades 54 are guided across them on the top. The hedge clipper blades 54 are driven by means of a drive unit 14, in which there is an excitation actuator 24, for instance an ultrasonic Langevin oscillator. To facilitate tool operation even in dark areas or at twilight, a work area light fixture 42 is disposed on the shaft of the hedge clipper blade 52 and is capable of illuminating both the hedge clipper blade 52 and part of the hedge 58 that is to be cut. For supplying the drive unit 14 with electrical signals, an electronic unit 20 and an operating voltage unit 22 are disposed directly on the drive unit 14. The electronic unit 20 serves to trigger the excitation actuator 24, and the requisite energy from the operating voltage unit 22 can be supplied by battery or by means of a power cord. On the housing of the modularly assembled electronic and operating voltage unit 20, 22, a user control part 12 for activating the hedge clipper 50 and an optical function display 38 are disposed, the latter in the form of a function display light, such as a function LED, which displays the active operation of the hedge clipper 50.

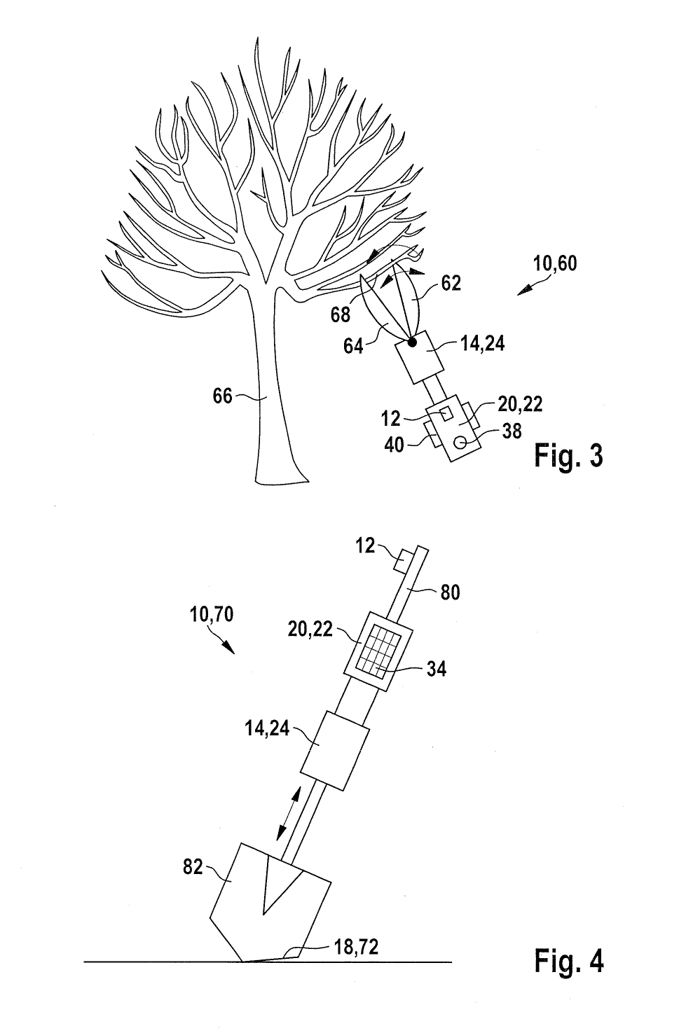

FIG. 3 schematically shows the use of an electric garden tool 10 as a branch lopper 60. The branch lopper 60 serves to cut off branches 68 of a tree 66. The branch lopper 60 includes a clipper that in turn includes a branch lopper blade 62 and fixed branch lopper counterpart blade 64. By means of a contrary tongs or scissors motion of the branch lopper blade 62 relative to the fixed counterpart blade 64, a cutting motion is performed for cutting off the branch 68 that is to be cut. An ultrasonic motion vibrating at high frequency, indicated by a double arrow, of the branch lopper blade 62 relative to the counterpart blade 64 serves on the one hand to reduce the cutting forces and for scoring the branch 68 that is to be cut. On the other hand, the mechanical excitation actuator 24 can also drive both blades 62, 64 in a contrary cutting motion, which can also be done manually. In a further embodiment, the branch lopper blade 62 can also be excited in the longitudinal direction of the blade by a high-frequency vibrating ultrasonic motion, so that the branch lopper blade 62 executes a cutting motion similar to a knife relative to the counterpart blade 64. For that purpose, the branch lopper blade 62, by means of the drive unit 14 in which there is an excitation actuator 24, is put mechanically into vibration. The drive unit 14 is supplied and controlled by an operating voltage unit 22 and electronic unit 20, on whose housing there are not only a user control part 12 for activating the branch lopper 60 but also an optical function display 38, in the form of an optical function LED or function display, and a haptic function display 40 that by vibrating slightly shows the user that the branch lopper 60 is in operation.

In FIG. 4, an exemplary embodiment of a garden tool 10 is shown as a spade 70. The spade 70 includes a spade handle 80 and a spade body 82. A drive unit 14, which includes an excitation actuator 24, is disposed on the spade handle 80 and serves to drive the spade body 82, and thus the working blade 18 embodied as a spade blade 72, with linear high-frequency oscillation, in order to make it easier to push the spade 70 into hard ground and root systems. The drive unit 14 is connected electrically to an operating voltage and electronic unit 20, 22 and can be activated and deactivated by means of a user control part 12 disposed on the upper end of the spade handle 80. A rechargeable battery is disposed inside the operating voltage unit 22 and can be charged by means of sunlight via a photovoltaic module unit 34, which is disposed on the housing of the operating voltage unit 22 and electronic unit 20. Since the spade is only ever used briefly, and most of the time it lies idle out in the open, the slight electrical energy that is made available by the photovoltaic module unit 34 during daylight hours can be used to charge the battery, so that the spade 70 is practically maintenance-free and remains ready for use for a long time, without additional electrical energy.

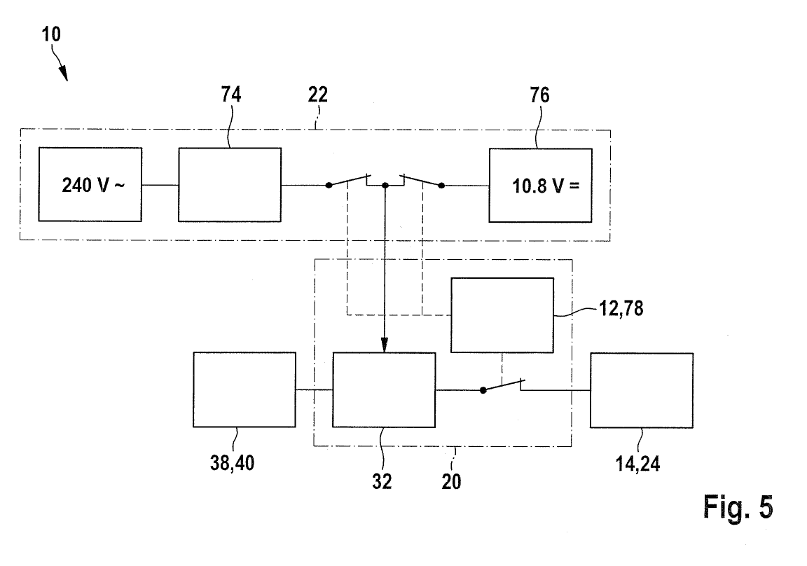

Finally, FIG. 5 shows a schematic diagram of the linkage of the various operating units of an ultrasonically excited garden tool 10. In schematic terms, the ultrasonically excited garden tool 10 includes an operating voltage unit 22, which makes an electrical operating voltage for operating the garden tool 10 available. The operating voltage unit 22 includes a plug-in voltage module 74, which from a voltage from the electrical grid, such as 240-Volt alternating voltage, can generate a 10.8-Volt direct voltage. The operating voltage unit 20 further includes a rechargeable battery voltage module 76, which furnishes the voltage supply by means of a rechargeable battery or a nonrechargeable battery and can recharge the battery via the plug-in voltage module 74. An electronic unit 20 in which there is a regulating unit 32 is connected to the operating voltage unit 22. The regulating unit 32 generates electrical regulating and control signals for operating an excitation actuator 24 that is located in the drive unit 14. For that purpose, the regulating unit 32 can have a feedback function, in order to follow up a resonant frequency of the mechanical drive system under varying resonant conditions and to make a frequency-adapted voltage supply available for operating the excitation actuator 24. An optical function display 38 and a haptic function display 40 are connected to the regulating unit 32 and can display the active operation of the garden tool 10 to the user. This is important, since the ultrasound excitation of the working blade takes place in a high-frequency range that is inaudible to the user, and injuries could result from touching the active working blade.

It is therefore also conceivable for further protective sensors, such as light gates, touch sensors, or the like, to be disposed in the garden tool 10, especially in the blade region 16, and when a dangerous state is detected, such as when a user's hand unintentionally comes near the working blade 18, or if there is an overload of the excitation actuator 24, a protective circuit 78 can perform a shutoff of all the current-carrying parts, and in particular can disconnect the regulating unit 32 from the plug-in voltage module 74 and the battery voltage module 76 and disconnects the regulating unit 32 from the drive unit 14 and from the excitation actuator 24, so that both the electronic unit 20 and the drive unit 14 are electrically shut off instantaneously.

By means of the invention, first, a technology is furnished for clean, safe and absolutely noiseless cutting of grass, branches or hedges; secondly, energy-saving and protective treatment of plants as well as an innovative drive concept for the garden activity are proposed.

The foregoing relates to preferred exemplary embodiments of the invention, it being understood that other variants and embodiments thereof are possible within the spirit and scope of the invention, the latter being defined by the appended claims.

1. A garden tool having at least one working blade for performing a cutting operation, including:
a user control part for user activation of the garden tool;
a drive unit for generating a working motion of the at least one working blade;
a blade region for a linear and/or oscillating working motion of the at least one driven working blade;
an electronic unit for acting upon the drive unit with at least control and/or regulating signals; and
an operating voltage unit for furnishing an electrical energy supply to the electronic unit, wherein the drive unit includes at least one excitation actuator having a volume of excitation-active material, which actuator is electrically supplied in operation by the operating voltage unit and is controlled or regulated by the electronic unit.

2. The garden tool as defined by claim 1, wherein the electronic unit is embodied for operating the at least one excitation actuator at a resonant frequency, and the electronic unit includes a roger with frequency adaptation for follow-up of the resonant frequency of the least one excitation actuator.

3. The garden tool as defined by claim 1, wherein the excitation-active material of at least one excitation actuator is piezoelectric or magnetostrictive, and the at least one excitation actuator can reach a vibration amplitude at a tip of the blade in a range of from 5 μm to 100 μm.

4. The garden tool as defined by claim 2, wherein the excitation-active material of at least one excitation actuator is piezoelectric or magnetostrictive, and the at least one excitation actuator can reach a vibration amplitude at a tip of the blade in a range of from 5 μm to 100 μm.

5. The garden tool as defined by claim 1, wherein an operating frequency of the at least one excitation actuator in operation is between 10 kHz and 1000 kHz, preferably between 15 kHz and 60 kHz, and in particular over 20 kHz.

6. The garden tool as defined by claim 2, wherein an operating frequency of the at least one excitation actuator in operation is between 10 kHz and 1000 kHz, preferably between 15 kHz and 60 kHz, and in particular over 20 kHz.

7. The garden tool as defined by claim 3, wherein an operating frequency of the at least one excitation actuator in operation is between 10 kHz and 1000 kHz, preferably between 15 kHz and 60 kHz, and in particular over 20 kHz.

8. The garden tool as defined by claim 4, wherein an operating frequency of the at least one excitation actuator in operation is between 10 kHz and 1000 kHz, preferably between 15 kHz and 60 kHz, and in particular over 20 kHz.

9. The garden tool as defined by claim 1, wherein the operating voltage unit includes an electrochemical reservoir, in particular a rechargeable electrochemical reservoir, and/or that the operating voltage unit includes a current generator, in particular a photovoltaic module unit or an internal combustion engine current generator for charging the rechargeable electrochemical reservoir.

10. The garden tool as defined by claim 8, wherein the operating voltage unit includes an electrochemical reservoir, in particular a rechargeable electrochemical reservoir, and/or that the operating voltage unit includes a current generator, in particular a photovoltaic module unit or an internal combustion engine current generator for charging the rechargeable electrochemical reservoir.

11. The garden tool as defined by claim 1, wherein the garden tool includes one or more optical and/or acoustic and/or haptic function displays for displaying an active state of the at least one excitation actuator.

12. The garden tool as defined by claim 10, wherein the garden tool includes one or more optical and/or acoustic and/or haptic function displays for displaying an active state of the at least one excitation actuator.

13. The garden tool as defined by claim 1, wherein the garden tool is embodied as a lawn mower, and the working blade is embodied as a grass-cutting blade, and the grass-cutting blade is movable by means of a carriage to an adjustable height above grass to be cut.

14. The garden tool as defined by claim 12, wherein the garden tool is embodied as a lawn mower, and the working blade is embodied as a grass-cutting blade, and the grass-cutting blade is movable by means of a carriage to an adjustable height above grass to be cut.

15. The garden tool as defined by claim 13, wherein the lawn mower includes a brush device, which can guide the grass to be cut toward the working blade by means of a brush motion, in particular a rotary brush motion.

16. The garden tool as defined by claim 14, wherein the lawn mower includes a brush device, which can guide the grass to be cut toward the working blade by means of a brush motion, in particular a rotary brush motion.

17. The garden tool as defined by claim 15, wherein cut material is fed into a collecting container with aid of the brush device and/or other feeding devices.

18. The garden tool as defined by claim 16, wherein cut material is fed into a collecting container with aid of the brush device and/or other feeding devices.

19. The garden tool as defined by claim 1, wherein the garden tool is embodied as a clipper, in particular as a hedge clipper, and the working blade is embodied in particular as a multi-blade hedge clipper with counterpart blades, or as a branch lopper in which the working blade is embodied as a branch lopper blade with a counterpart blade.

20. The garden tool as defined by claim 1, wherein the garden tool is embodied as a spade or verticulator, and the working blade is embodied as a spade blade or as one or more verticulator blades.
